(19) United States
(12) Patent Application Publication
(10) Pub. No.: US 2020/0136829 A1
(43) Pub. Date: Apr. 30, 2020

(54) Data Management System Using Multiple Blockchains

(71) Applicant: American CryptoCoupon, Inc., Dallas, TX (US)

(72) Inventors: Neil Keon, Dallas, TX (US); Michael Cho, Dallas, TX (US)

(21) Appl. No.: 16/656,246

(22) Filed: Oct. 17, 2019

Related U.S. Application Data
(60) Provisional application No. 62/750,766, filed on Oct. 25, 2018.

(51) Int. Cl. H04L 9/32; G06Q 20/40; H04L 9/06

(52) U.S. Cl. CPC H04L 9/3236; G06Q 20/401; H04L 2209/56; H04L 2209/38; H04L 9/0637

(57) ABSTRACT

A message is received containing a notification of a change to a longterm value. The one or more longterm accounts are updated. After updating the longterm blockchain, one or more transaction accounts are updated by an update amount, the update amount generated based on the change to the one or more longterm accounts such that a total value of all transaction accounts in the transaction blockchain is based on an aggregate measure of all of the longterm accounts in the longterm blockchain.

### CROSS-REFERENCE TO RELATED APPLICATION

This application claims priority to U.S. Provisional Patent Application No. 62/750,766, filed Oct. 25, 2018, the entire contents of which are incorporated herein by reference.

### TECHNICAL FIELD

This application is related to network data processing using blockchains.

### BACKGROUND

A blockchain is a growing list of records, called blocks, which are linked using cryptography. Each block often contains a cryptographic hash of the previous block, a timestamp, and transaction data. For use as a distributed ledger, a blockchain is typically managed by a peer-to-peer network collectively adhering to a protocol for inter-node communication and validating new blocks.

### SUMMARY

In one implementation a system is used for the maintenance of a plurality of blockchains. The system comprises one or more servers. Each servers comprises at least one processor and computer memory. The servers are configured to perform operations including receive a message containing a notification of a change to a longterm value that is recorded outside of a longterm blockchain comprising one or more longterm accounts responsive to receiving the message containing the notification, updating the one or more longterm accounts in the longterm blockchain to record the change to the longterm value that is recorded outside of the longterm blockchain; after updating the longterm blockchain, updating, in a transaction blockchain, separate from the longterm blockchain, one or more transaction accounts by an update amount, the update amount generated based on the change to the one or more longterm accounts such that a total value of all transaction accounts in the transaction blockchain is based on an aggregate measure of all of the longterm accounts in the longterm blockchain. In other implementations, methods, products, devices, and software may be used for the maintenance of a plurality of blockchains

Implementations can include one, none, or some of the following features. The operations further comprise receiving a request to transfer a transfer value from a first transaction account in the transaction blockchain; transmitting, based on receiving the request to transfer value from the first transaction account, a primary-glyph, the primary-glyph comprising elements that encode at least some of the information about the request to transfer value from the first transaction account; receiving, after transmitting the primary-glyph, a transfer-completion message that includes at least some of the information about the request to transfer value from the first transaction account. The operations further comprise responsive to the receiving of the request to transfer a transfer value from a first transaction account in the transaction blockchain: generating the primary-glyph by encoding the least some of the information about the request to transfer value from the first transaction account into a renderable data object; and selecting one or more associated-glyphs; and wherein transmitting the primary-glyph comprises transmitting the associated-glyphs. The transfer-completion message further includes an indication that a client-device scanned the primary-glyph and the one or more associated-glyphs. The primary-glyph is a GS1 databar barcode and wherein the associated-glyphs are Universal Product Code (UPC) barcode. At least some of the servers use one or more virtual-servers to perform at least some of the operations. Updating, in a transaction blockchain, one or more transaction accounts by an update amount is performed responsive to and based on the updating of the longterm blockchain.

Implementations can provide some, all, or none of the following features. Two blockchains can be used to separate related, but dissimilar blockchain transactions. This can allow greater transparency and legibility. Be sequestering high-importance, public, and/or low-frequency updates into one blockchain, while low-importance, private, and/or high-frequency updates are sequestered into another blockchain, users can quickly identify those transactions that are important (or important to them) by examining the first blockchain and ignoring the second blockchain. However, by linking some properties of the two blockchains, high-frequency updates may be carried out constrained by the state of the first blockchain. With this, the technology of blockchain-based data management is advanced and improved.

Such technology can allow for many possible use-cases. In one example use case, the first blockchain can be used to reflect a real-world asset. Value of the asset may be determined, and currency may be issued in the second blockchain in an amount based on the asset value (e.g., exactly the same, a fraction thereof, a multiple thereof.) The currency may then be traded in the blockchain with confidence that the currency is backed by the asset tracked in the first block chain. With this, the technology of blockchain-based currency is advanced and improved.

In some examples, the currency transactions can be executed by the use of displaying and scanning glyphs such as bar codes. These bar codes may be displayed in the format of Universal Product Codes (UPCs) and GS1 databar barcodes. Then, these barcodes may be used by point-of-sale systems to execute a transfer from one currency account to another. With this, the technology of blockchain-based currency is advanced and improved.

### DESCRIPTION OF DRAWINGS

FIG. 1A is a block diagram of an example system for the maintenance of multiple blockchains.

FIG. 1B is a schematic diagram of data storage in a system with multiple blockchains.

FIG. 2 shows an example computer interface.

FIG. 3 is a block diagram of an example system for updating a blockchain.

FIGS. 4A and 4B show examples of data storage in a blockchain.

FIG. 5A shows an example of devices transacting a cryptocurrency transaction.

FIG. 5B shows an example of sidechain data storing data for a device.

FIG. 6 is a schematic diagram that shows an example of a computing device and a mobile computing device.

Like reference symbols in the various drawings indicate like elements

### DETAILED DESCRIPTION

This document describes technology in which a data-management system uses two blockchains to manage data. One blockchain is a longterm blockchain, which is used to record data records that are expected to be stable over long periods of time. The other blockchain is a transaction blockchain, which is used to record transactions that occur within the constraint of the longterm blockchain. For example, if the longterm blockchain records a particular value reflective of a phenomenon outside of the data-management system (a so-called “real-world value”), the transaction blockchain can record transactions in transaction accounts constrained to never have an aggregate value greater than the particular value.

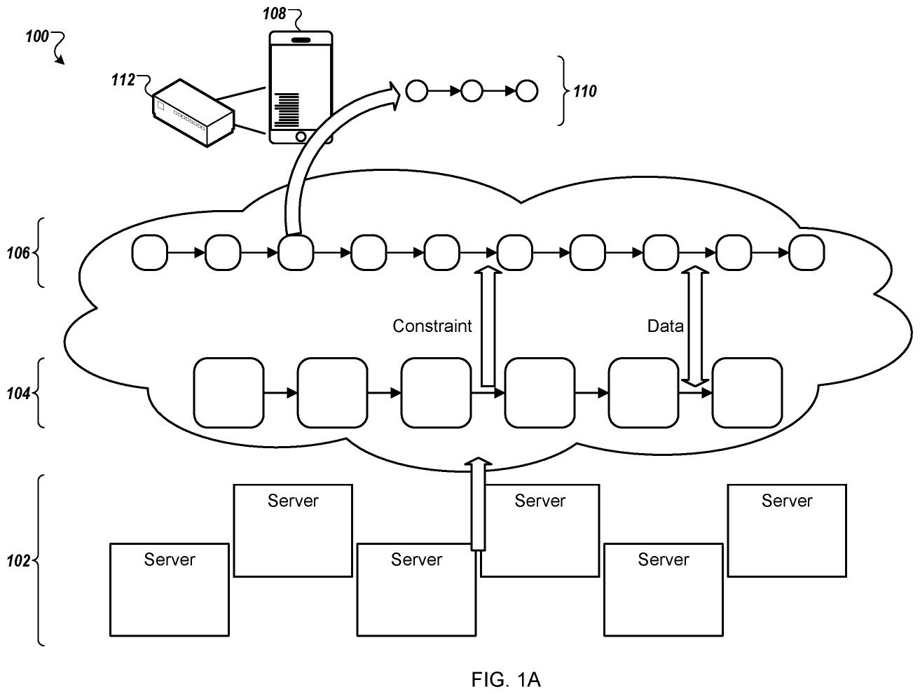

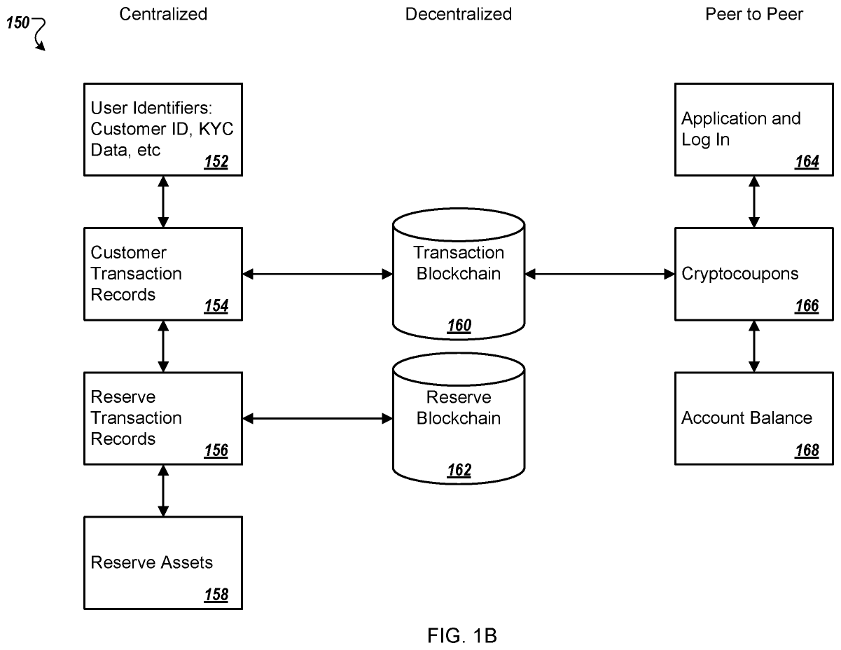

FIG. 1A is a block diagram of an example system 100 for the maintenance of multiple blockchains. In the system 100, one or more physical servers 102 are used to collectively maintain at least a longterm blockchain 104 and a transaction blockchain 106. In addition, a client device 108 can maintain a sidechain 110 and operate with a scanner 112 to perform transactions in either or both of the sidechain 110 and the transaction blockchain 106.

The physical servers 102 may take any technologically appropriate distribution of location, type, performance, etc. and can incorporate, for example, at least one processor and computer memory. The physical servers 102 may all reside in a single data center, or may be spread out across multiple geographic locations. They physical servers 102 may all be the same make and model of hardware running identical software, or they may be a heterogeneous collection of hardware and software configurations. The physical servers 102 may all be owned and/or administered by the same entity, or they may be owned and/or administered by various different entities that cause the physical servers 102 to operate together. This may include some servers 102 that only perform particular tasks (e.g., some mining servers only performing mining operations, some account servers only operating off-blockchain account management information, etc.) Some or all of the physical servers 102 may instantiate virtual servers to perform at least some of their operations. These virtual servers may appear to external systems as distinctly virtual servers, or they may appear as though they were physical servers 102.

The physical servers 102 can operate to maintain the longterm blockchain 104 and the transaction blockchain 106. For example, the servers 102 may cause the longterm blockchain to maintain one or more values based on phenomena outside of the system 100. The server 102 can receive a message containing a notification of a change to a longterm value outside of the longterm blockchain 104. For example, a sensor can send a message to a physical server 102, a client device (not shown) can send a message to a physical server 102 etc. In general, the system 100 can be configured under the assumption that the longterm blockchain 104 will receive relatively few updates of this type, compared to the number of transactions that occur within the transaction blockchain 106.

Responsive to receiving the message containing the notification, updating one or more longterm accounts in the longterm blockchain to record the change to the longterm value outside of the longterm blockchain. For example, the longterm blockchain 104 may store a value for the phenomena, and when an update is received, the physical server 102 may update the value recorded in the longterm blockchain 104. This updated value in the longterm blockchain 104 may be exactly the updated value received, or may be derived from the value received. For example, the value received may be multiplied by a confidence or weight value to produce a fraction or multiple, or a more complex computation can be applied (e.g., the maximum value from the past N received, excluding outliers).

After the updating of the longterm blockchain, the physical servers 102 can update the transaction blockchain 106. For example, one or more transaction accounts of the transaction blockchain 106 may be updated by an update amount. That is to say, if the update amount calls for an increase in some longterm account by a value of 10, the physical servers can update one or more transaction accounts in the transaction server 106 by a total of ten. This may be increasing one account by 10, increasing ten accounts by 1, making increases of 3, 2, 7, and −2 which summate to a value of 10.

The physical servers thus update the amount generated based on the change to the longterm accounts such that a total value of all transaction accounts in the transaction blockchain is based on an aggregate measure of all of the longterm accounts in the longterm blockchain. In this way, the physical servers 102 constrain the values of the transaction blockchain 106 based on data values in the lonterm blockchain 104. For example, if the value in the longterm blockchain 104 is 335, then the servers 102 can ensure that the sum total of all corresponding values in the transaction blockchain 106 summate to exactly, or no more than, 335 at any point (or a multiple of, fraction of, function result of, etc.) If, for example, all transaction account values summate to 335, the physical servers 102 can ensure that any transaction between two transaction accounts nets to a 0 value. One such example of a transaction with a net 0 value is a credit of 17 to a first transaction account and a debit of 17 to a second transaction account, which has a net value of 17-17 or 0.

Some of the updating in the transaction blockchain 106 to the transaction accounts is performed responsive to and based on the updating of the longterm blockchain. For example, in some configurations, as part of completing or approving an update to the longterm blockchain 104, the physical servers 102 may also programmatically also update the transaction blockchain 106 by the same (or related) amount. However, in other examples, the physical servers 102 may update the transaction blockchain 106 after updating the longterm blockchain 104, but not immediately responsive to doing so. For example, the physical servers 102 may operate on a schedule so that each day at midnight, or after a given number of update to the longeterm blockchain 104, the physical servers 102 update the transaction blockchain 106.

Transactions in the transaction blockchain 106 may be initiated by the physical servers 102 or by other devices such as the client device 108 and/or the scanner 112. In some cases, transactions may be initiated by the client device 108 working in conjunction with the scanner 112, and then verified by the physical servers 102 operating as miners for the transaction blockchain 106. As will be understood, the client device 108 and/or the scanner 112 may operate as one of the physical servers 102.

The system 100 may be used for a wide array of use cases. In one use case, the system 100 may be used to monitor and predict the state of chaotic physical phenomena. For example, the system 100 can be used to model the behavior of atmospheric clouds. In this example, the longterm blockchain 104 can be used to store sensor data that records the location, opacity, humidity, and temperature of clouds at various monitoring stations. Then, the transaction blockchain 106 can be populated with proxy values in transaction accounts that represent proxy readings at locations that do not have sensors. Client devices 108 may then execute meteorological algorithms that attempt to solve complex calculations at the proxy locations (i.e. the transaction accounts) given the constraints imposed by the stored values in the longterm blockchain 104. Later, when new sensor data is available, the calculations for the proxy locations can be performed again using the new constraints.

In another use case, an augmented-reality video game system uses the system 100. In this example, the game publisher maintains a virtual game system in which various natural resources become available (e.g., stone and logs for building structures, gold and jewels that can be crafted in-game into character skins). Each player may have a corresponding transaction account in the transaction server 106, and when the player performs in-game actions to harvest resources (e.g., collecting stones, mining for gold, cutting gems into jewels), the client 108 can initiate a transaction to increase the player's stored resources. If there are available resources, the physical servers 102 can allocate the unused resources to the player. Then, when players congregate and physically meet, they can use their phones to act as the client device 108 and 112 to execute a trade. The offering player can display one or more glyphs on their client device 108 (i.e. their phone), and the accepting player can scan the glyphs with their scanner 112 (i.e. their phone). If the client device 108 and/or scanner 112 is offline, the transactions can be temporarily stored in the sidechain 110, and if the devices are online, the transactions can be stored in the transaction blockchain 106.

In another use case, an asset-backed cryptocurrency can be created with the use of the system 100. As a managing organization amasses assets (e.g., fiat currency, precious metals, commodity goods, stocks, bonds, other cryptocurrency), the value of these assets may be recorded in the longterm blockchain 104. Then, cryptocurrency can be minted in the transaction blockchain 106. For fully backed cryptocurrency, the physical servers 102 may mint exactly, and no more than, the value of the assets recorded in the longterm blockchain 106. For a fractionally backed cryptocurrency, the physical servers 102 may mint a multiple (e.g., 120%, 200%, 1,000%) of the asset value in cryptocurrency. For a more conservative cryptocurrency, the physical servers 102 may mint only a portion of the value of the asset (e.g., 99%, 50%, 1%, 0.001%) as cryptocurrency. Then, as the total value of the asset fluctuates, either through purchase/sales or through changes in valuation, the longterm blockchain 104 can be updated by minting or buying back cryptocurrency in circulation in the transactional blockchain.

FIG. 1B is a schematic diagram of data storage in a system 150 with multiple blockchains. The system 150 shows data storage for an asset-backed cryptocurrency. However, other uses are possible including, but not limited to, those described elsewhere in this document.

User identifiers 150 are created in a centralized process and stored in a decentralized transaction blockchain 160. For example, unique customer identifiers, Know Your Customer (KYD) data required by financial regulators, and other user identifiers may be collected by an organization that operates the cryptocurrency.

Customer transaction records 154 can be generated for storage and/or collected from storage in the transaction blockchain 150. For example, the transaction records may be generated in the transaction blockchain 160 in the course of usage of the cryptocurrency by the users described in the user identifiers 152. The transaction blockchain 160 can be examined to extract or reconstruct the customer transaction records 154 by a single client device.

Reserve transaction records 156 can record transactions that involve reserve assets 158. For example the reserve assets 158 may record the balance of fiat currency, other cryptocurrency, stocks, bonds, precious metals, real-estate holdings, etc. that are considered to have value as an asset. Transaction 156 of such reserves (purchases/sales etc.) can be recorded in the reserve blockchain 162.

Application data and log in events 164 can be stored and created on peer to peer devices such as mobile phones, scanners, etc. These devices can exchange cryptocoupons 166 or other cryptocurrency, which can alter account balances 168. Records of such transaction can be stored in the transaction blockchain 160.

Changes to some data in the system 150 can result in updates to other portions of the data in the system 150. In some cases, a transaction intended to convert cryptocurrency to fiat may result in a change to the reserve assets and thus the reserve blockchain 162. For example, a user may use an application 164 to buy-out of the cryptocoupon currency. This can result in a transaction in the transaction blockchain (the user turning in their cryptocoupon 166) and a transaction in the reserve transaction record 156 and the reserve assets 158 (the user receiving an equal value of the assets. In this way, information may flow from the transaction blockchain to the reserve blockchain 160 (as in this examples) as well as from the reserve blockchain 162 to the transaction blockchain 160 (as would be the case when new assets are purchases in order to issue more cryptocoupons into circulation).

Use of the technology described here and elsewhere in the document can provide a number of advantages. For example, the crytopcurrency described here may be able to avoid or reduce the impact of a run. A run can be prevented by permitted the cryptocoupons to be exchanged for the backing assets (or for currency received from the sale of the backing assets). In such a way, other users will see that any user buying out of the cryptocurrency is receiving their buy-out value from known, identifiable assets. This can reduce the fear the other users have about their own ability to cash-out, reducing or eliminating their fear-based desire to also cash out, which can otherwise produce a run on the cryptocurrency. As such, a run is avoided and the cryptocurrency can be orderly liquidated if that is the desire of the users of the cryptocurrency.

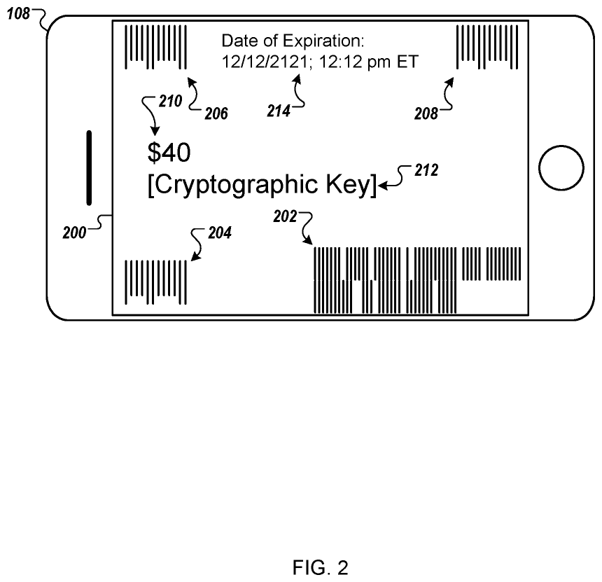

FIG. 2 shows an example computer interface 200. The computer interface 200 is shown here being displayed by a phone, but it will be understood that other hardware devices (e.g., tablet, laptop, watch, laser-printer) may be used to generate the computer interface 200 on a screen, on a paper, etc.

The computer interface 200 can be generated by the client device 108 as part of initiating a transaction in the transaction blockchain 106 with the scanner 112. For example, the user of the client device 108 may use an application to request a $40 transfer from their transaction account to the transaction account of the entity that owns the scanner 112. The application may send, to a physical server 102, the request and receive back glyphs 202, 204, 206, and 208. The client device 108 can then display the glyphs 202, 204, 206, and 208 for scanning by the scanner 112.

In this example, the glyph 202 is a GS1 databar barcode and the glyphs 204, 206, and 204 Universal Product Code (UPC) barcodes. These have been created or accessed by the physical servers 102 for use in the proposed transaction and transmitted to the client device 108 for display. These glyphs 202, 204, 206, and 208 each encode data used by the elements of the system 100 to execute a transaction in the transaction blockchain 106.

The computer interface 200 can display other information about the proposed transaction. Shown here, the transaction amount 210, a cryptographic key 212 which has been encoded into one of the glyphs, and an expiration date are displayed.

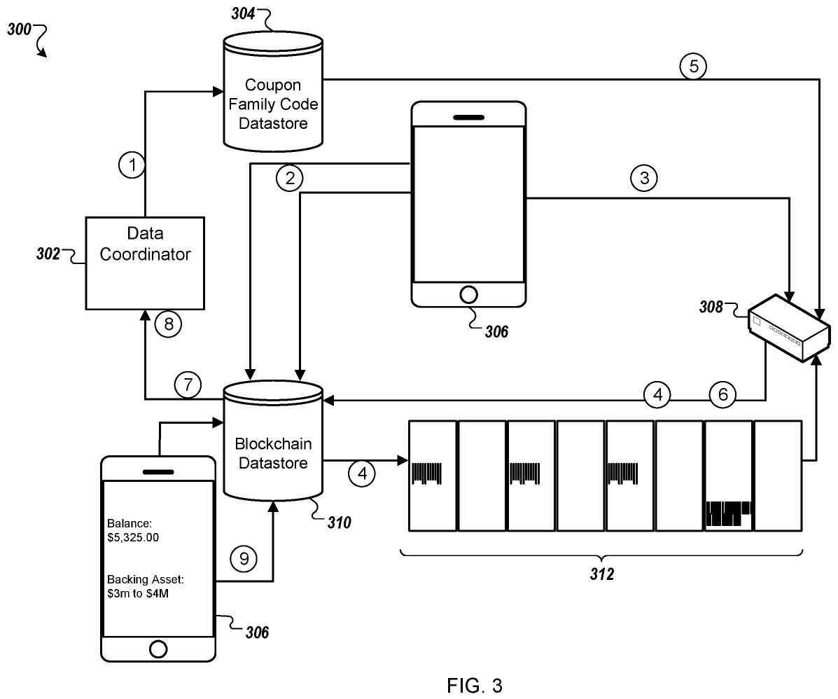

FIG. 3 is a block diagram of an example system 300 for updating a blockchain. In the system 300, a longterm blockchain and a transaction blockchain are being used to create a cryptocurrency transaction. A data coordinator 302 is a computer system responsible for generating glyphs that are encoded with various data, including the creation of glyphs that can be used as coupons in retail point-of-sale transactions. A coupon family datastore 304 stores data related to coupons. This can include their barcodes, associated product families, etc. A client device 306 can be used by a user to initiate transactions by requesting and displaying glyphs. A scanner 308 can be used by another use to confirm the transaction by approving a scan of the glyphs.

The data coordinator 302 can be one or more physical servers that coordinates data in the system 300. For example, the data coordinator 302 can manage a namespace in the coupon family code datastore 304 to index manufacturers, products, and product families for organizing coupon glyphs (e.g., GS1 databar barcodes and UPC barcodes). In addition, the data coordinator 302 can be responsible for other activities described elsewhere in this document including receiving an update to an external phenomena, making a corresponding update to a longterm blockchain account value, minting cryptocurrency, etc.

The coupon family code datastore 304 can include one or more monolithic or distributed datastores that can accept data from the data coordinator 302 and provide responses to queries from the scanner 308. The blockchain datastore 310 can include one or more monolithic or distributed datastore that can store data related to one or more blockchains. For example, the blockchain datastore 310 may store data of a transaction blockchain, a transaction blockchain and a longterm blockchain, or other configurations. In some cases, the data coordinator 302, the coupon family datastore 304, and the blockchain datastore 310 may all be hosted on the physical servers 102.

Client device 306 and scanner 308 can be any technologically appropriate devices that are able to communicate with other elements of the system 300. The client device 306 can display one or more computer interfaces 312, and the scanner 308 can scan the computer interfaces 312 to identify and decode the glyphs.

A data coordinator 302 can generate primary-glyphs (e.g., GS1 databars) by encoding information into a renderable data object. In some cases, this may be done before other operations described here. For example, the data coordinator 302 can pre-generate primary glyphs for common transaction amounts for later use. In some cases, the data coordinator 302 can dynamically generate the primary-glyphs. For example, the data coordinator 302 can receive (not shown) a request to transfer a transfer value from a first transaction account in the transaction blockchain that is controlled by the owner of the client device 306. In response, the data coordinator 302 can generate a primary glyph for that transaction. In such a case, the primary glyph may be generated to encode some information about the request (e.g., the value, a sending or receiving address). The data coordinator can generate other associated data such as secondary glyphs (e.g., UPC barcodes), coupon family data, etc. for storage in the coupon family code datastore 304, for transmission to the client device 306, etc. Additionally or alternatively, the primary data for the primary glyph may be used by the user device to generate the glyph.

The client device 306 can initiate a transfer in the blockchain datastore 310 by displaying the primary and secondary glyphs with the computer interfaces 312.

Shown here, the computer interfaces 312 show the primary and secondary glyphs in sequential screen. First, the secondary glyphs are displayed, then the primary glyph is displayed. This may be useful, for example, if the scanner 308 is part of a point-of-sale system in a retail store. In such a case, the users can scan each secondary glyph (e.g., UPC barcode) and then the primary glyph (e.g., GS1 databar barcode) using the same workflow as that used for paper-based manufacturers coupons. Such a configuration can provide the technical advantage of reducing end-user input complexity because the technology of system 300 is able to perform different operations with a unified input arrangement, which, in less advantageous technology, could require two different workflows. However, other configurations are possible. For example, the computer interface 200 shows multiple glyphs at once.

After scanning the glyphs, the scanner 308 can confirm the validly of the glyphs. For example, the scanner can send, to the coupon family code datastore 304 a query with the values decoded from the primary glyph and the secondary glyphs. The coupon family code datastore 304 can return a true if the secondary glyphs (e.g., UPC barcodes) represent data entries that meet the requirements of the primary glyph (e.g., GS1 databar barcode). In this example, the primary glyph specifies three items from three different product families and will return true if the three secondary glyphs represent data entries within those three families. As will be understood, other numbers and family structures (e.g., 1 secondary glyph for a data entry in a family of only 1) are possible.

After confirming the validity of the primary glyph for the associated glyphs, the scanner 308 can report completion of the scanning to the blockchain datastore 310. This completion message can include at least some of the information about the request to transfer value from the first transaction account such as an address, a value, a timestamp, etc. Tis completion message can also include an indication that the scanner 308 scanned the primary glyph (e.g., GS1 databar barcode) and the one or more associated-glyphs (UPC barcode). For example, the encoded data can be included, a hash of such data can be included, or a flag in the message can be set to true indicating that the scan took place as opposed to, e.g.., manual entry of data.

Once received, the blockchain datastore 310 can update the transaction blockchain. For example, miners for the transaction blockchain can validate the transaction and the transaction can be appended to the end of the transaction blockchain or into an appropriate sidechain.

The client device 306 may then be used to show data from the blockchain datastore. In this example, the client device 306 shows a value from the transaction blockchain (e.g., the particular user's private account balance) and a value from the longterm blockchain (e.g., the total asset value recorded for the backing assets).

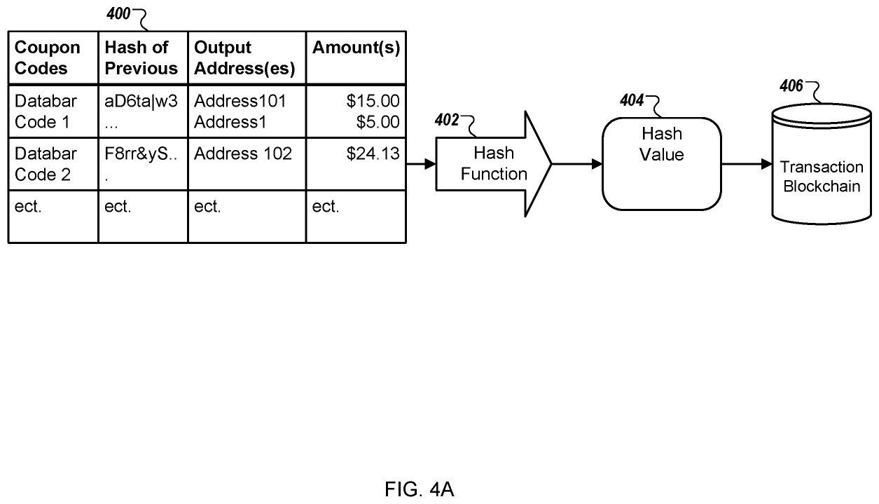

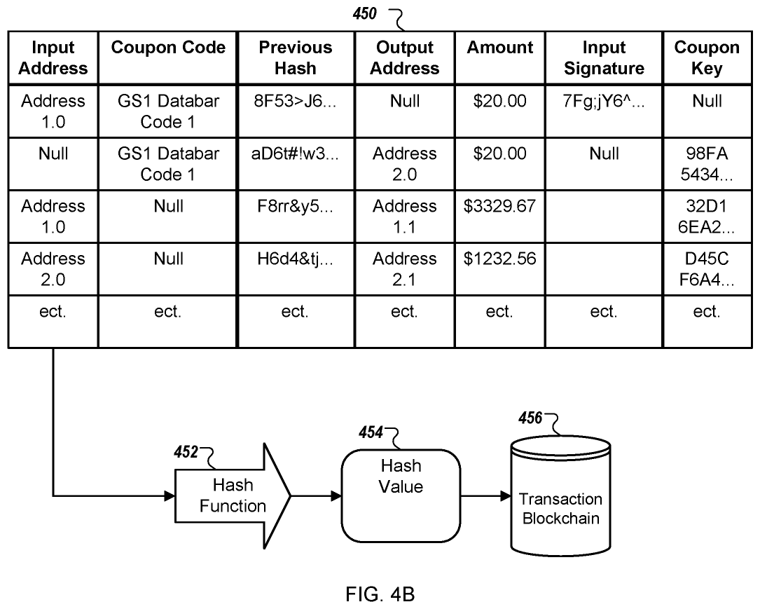

FIG. 4A shows an example of data storage in a blockchain. Here, one or more data records 400 record a transaction. The data records 400 may be recorded, for example, in a sidechain maintained by a client device or in a transaction blockchain. The data records 400 can be passed through a hash function 402 to generate a hash value 404. The hash function 402 can include one or more mathematical functions that receive a string of bits and deterministically generates an output string of bits called the hash value 404. In many cases, all hash values 404 is of a fixed length regardless of the size of the input, and using the hash value 404 determining the input data is either impossible or mathematically prohibitive. As will be understood, the values of the data record can be verified using the hash function 402 and the hash value 404. After the hash value 404 is created, the miners (e.g., some of the physical servers 102 and their associated software) of the transaction blockchain can append the hash value to the transaction blockchain 406. In some configurations, this can allow for private knowledge of some or all of the data records 400 but public recordation of their hash values 404.

FIG. 4B shows an example of data storage in a blockchain. Here, one or more data records 450 record a transaction with stricter mapping of public and private keys and addresses as may be found in some other configurations.

The data records 450 may be recorded, for example, in a sidechain maintained by a client device or in a transaction blockchain. The data records 450 can be passed through a hash function 452 to generate a hash value 454. The hash function 452 can include one or more mathematical functions that receive a string of bits and deterministically generates an output string of bits called the hash value 454. In many cases, all hash values 454 is of a fixed length regardless of the size of the input, and using the hash value 404 determining the input data is either impossible or mathematically prohibitive. As will be understood, the values of the data record can be verified using the hash function 452 and the hash value 454. After the hash value 454 is created, the miners (e.g., some of the physical servers 102 and their associated software) of the transaction blockchain can append the hash value to the transaction blockchain 456. In some configurations, this can allow for private knowledge of some or all of the data records 450 but public recordation of their hash values 454.

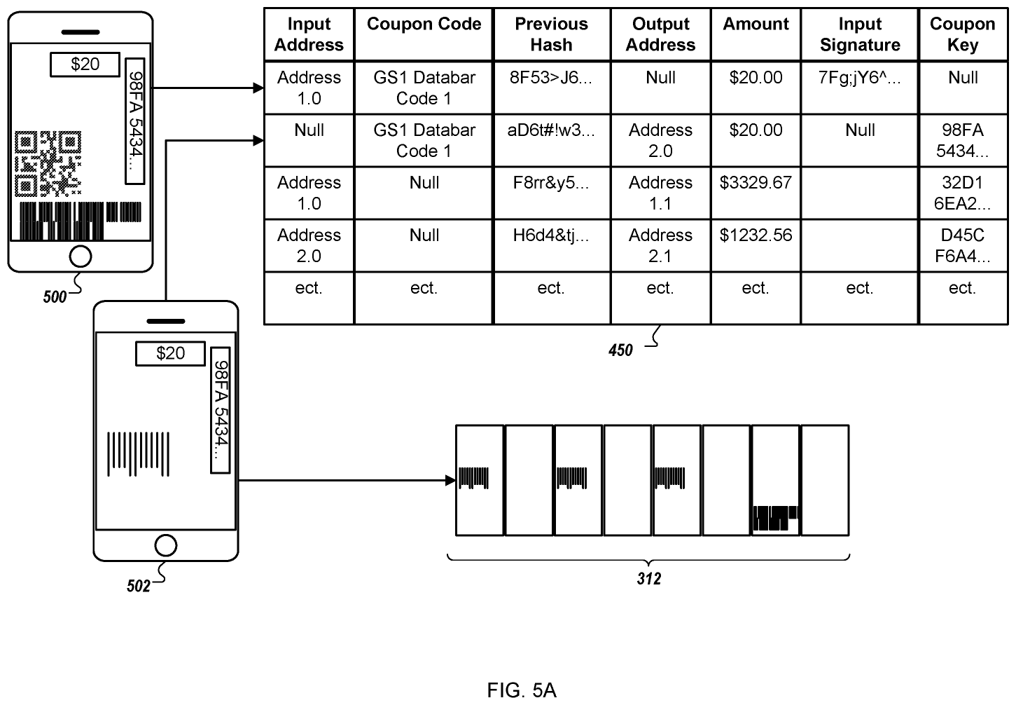

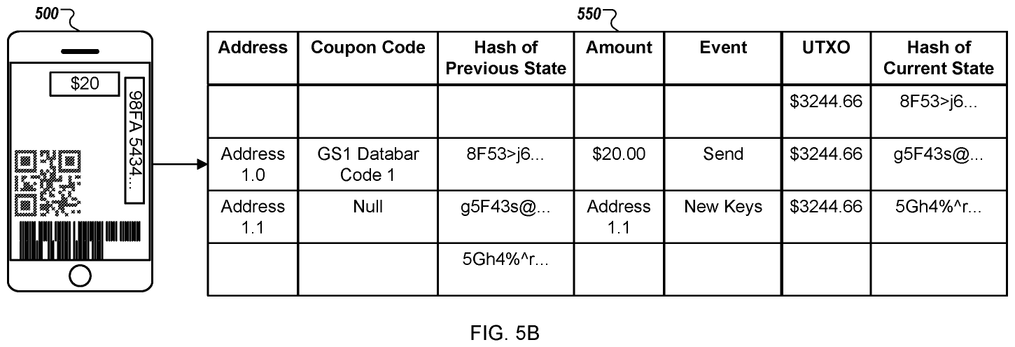

FIG. 5A shows an example of devices 500 and 502 transacting a cryptocurrency transaction. As shown here, the devices operate together to generate the data records 450. The device 502 can display screens 312 to be scanned by the user device 500. In doing so, the device 502 can generate the appropriate elements of the data records 200 and the device 502 can generate the appropriate data records 504. As will be understood, the owners of the devices 500 and 502 may use the devices 500 and 502 as part of a financial transaction (e.g., a sale of a physical good, payment for a service). With the use of the device 500 and 502 and associated cryptocoupons, the users can advantageously conduct a cryptocurrency transaction without having to physically transfer physical money and without having to type complicated encryption keys or blockchain addresses.

FIG. 5B shows an example of sidechain data 550 storing data for a device 500. For example, the device 500 can store the sidechain data 550 after completing the transaction with the device 502 as previously described.

By using the sidechain as shown here, the user of the device 500 can be advantageously protected from the impact of theft or loss. For example, the loss of control of the device can be registered with the transaction blockchain along with a timestamp. Every sidechain entry after the timestamp can be blacklisted to prevent commitment to the transaction blockchain. As such, the user can be protected from loss of currency after the report of the loss of control due to theft or loss of the device 500.

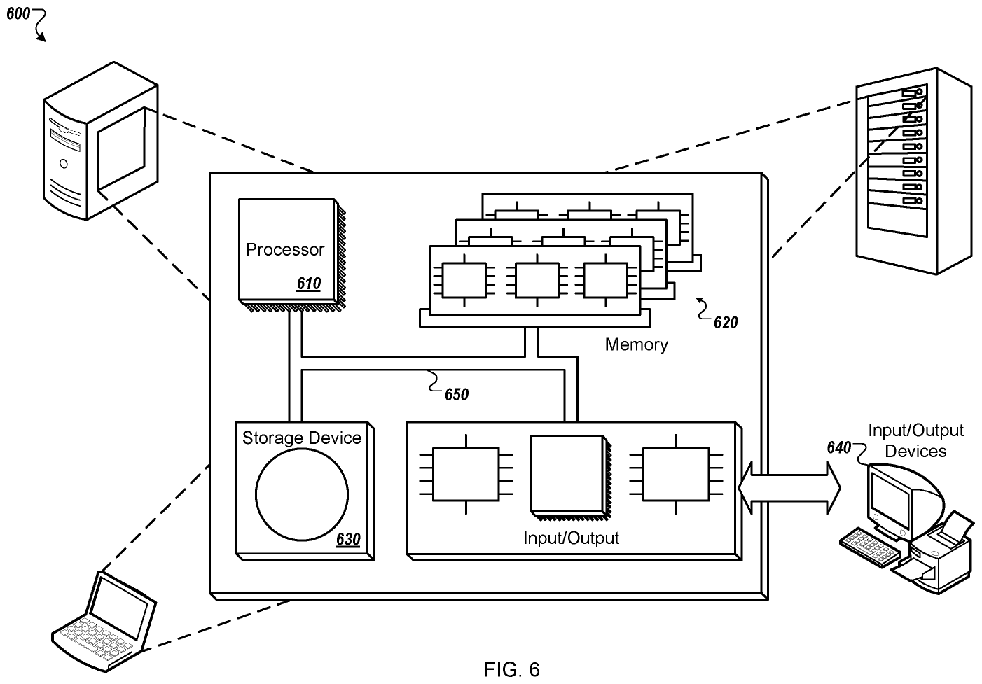

FIG. 6 is a schematic diagram that shows an example of a computing system 600. The computing system 600 can be used for some or all of the operations described previously, according to some implementations. The computing system 600 includes a processor 610, a memory 620, a storage device 630, and an input/output device 640. Each of the processor 610, the memory 620, the storage device 630, and the input/output device 640 are interconnected using a system bus 650. The processor 610 is capable of processing instructions for execution within the computing system 600. In some implementations, the processor 610 is a single-threaded processor. In some implementations, the processor 610 is a multi-threaded processor. The processor 610 is capable of processing instructions stored in the memory 620 or on the storage device 630 to display graphical information for a user interface on the input/output device 640.

The memory 620 stores information within the computing system 600. In some implementations, the memory 620 is a computer-readable medium. In some implementations, the memory 620 is a volatile memory unit. In some implementations, the memory 620 is a non-volatile memory unit.

The storage device 630 is capable of providing mass storage for the computing system 600. In some implementations, the storage device 630 is a computer-readable medium. In various different implementations, the storage device 630 may be a floppy disk device, a hard disk device, an optical disk device, or a tape device.

The input/output device 640 provides input/output operations for the computing system 600. In some implementations, the input/output device 640 includes a keyboard and/or pointing device. In some implementations, the input/output device 640 includes a display unit for displaying graphical user interfaces.

Some features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM (erasable programmable read-only memory), EEPROM (electrically erasable programmable read-only memory), and flash memory devices; magnetic disks such as internal hard disks and removable disks; magneto-optical disks; and CD-ROM (compact disc read-only memory) and DVD-ROM (digital versatile disc read-only memory) disks. The processor and the memory can be supplemented by, or incorporated in, ASICs (application-specific integrated circuits).

To provide for interaction with a user, some features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

Some features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN (local area network), a WAN (wide area network), and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

What is claimed is:

1. A system for the maintenance of a plurality of blockchains, the system comprising:
one or more servers, each servers comprising at least one processor and computer memory, the servers configured to perform operations including:
receive a message containing a notification of a change to a longterm value that is recorded outside of a longterm blockchain comprising one or more longterm accounts;
responsive to receiving the message containing the notification, updating the one or more longterm accounts in the longterm blockchain to record the change to the longterm value that is recorded outside of the longterm blockchain;
after updating the longterm blockchain, updating, in a transaction blockchain, separate from the longterm blockchain, one or more transaction accounts by an update amount, the update amount generated based on the change to the one or more longterm accounts such that a total value of all transaction accounts in the transaction blockchain is based on an aggregate measure of all of the longterm accounts in the longterm blockchain.

2. The system of claim 1, wherein the operations further comprise:
receiving a request to transfer a transfer value from a first transaction account in the transaction blockchain;
transmitting, based on receiving the request to transfer value from the first transaction account, a primary-glyph, the primary-glyph comprising elements that encode at least some of the information about the request to transfer value from the first transaction account;
receiving, after transmitting the primary-glyph, a transfer-completion message that includes at least some of the information about the request to transfer value from the first transaction account.

3. The system of claim 2, wherein the operations further comprise transferring the transfer value from the first transaction account to a second transaction account in the transaction blockchain.

4. The system of claim 2, wherein the operations further comprise:
responsive to the receiving of the request to transfer a transfer value from a first transaction account in the transaction blockchain:
generating the primary-glyph by encoding the least some of the information about the request to transfer value from the first transaction account into a renderable data object; and
selecting one or more associated-glyphs; and
wherein transmitting the primary-glyph comprises transmitting the associated-glyphs.

5. The system of claim 4, wherein the transfer-completion message further includes an indication that a client-device scanned the primary-glyph and the one or more associated-glyphs.

6. The system of claim 4, wherein the primary-glyph is a GS1 databar barcode and wherein the associated-glyphs are Universal Product Code (UPC) barcode.

7. The system of claim 1, wherein at least some of the servers use one or more virtual-servers to perform at least some of the operations.

8. The system of claim 1, wherein updating, in a transaction blockchain, one or more transaction accounts by an update amount is performed responsive to and based on the updating of the longterm blockchain.

9. A method comprising:
receive a message containing a notification of a change to a longterm value that is recorded outside of a longterm blockchain comprising one or more longterm accounts;
responsive to receiving the message containing the notification, updating the one or more longterm accounts in the longterm blockchain to record the change to the longterm value that is recorded outside of the longterm blockchain;
after updating the longterm blockchain, updating, in a transaction blockchain, separate from the longterm blockchain, one or more transaction accounts by an update amount, the update amount generated based on the change to the one or more longterm accounts such that a total value of all transaction accounts in the transaction blockchain is based on an aggregate measure of all of the longterm accounts in the longterm blockchain.

10. The method of claim 9, wherein the operations further comprise:
receiving a request to transfer a transfer value from a first transaction account in the transaction blockchain;
transmitting, based on receiving the request to transfer value from the first transaction account, a primary-glyph, the primary-glyph comprising elements that encode at least some of the information about the request to transfer value from the first transaction account;
receiving, after transmitting the primary-glyph, a transfer-completion message that includes at least some of the information about the request to transfer value from the first transaction account.

11. The method of claim 10, wherein the operations further comprise transferring the transfer value from the first transaction account to a second transaction account in the transaction blockchain.

12. The method of claim 10, wherein the operations further comprise:
responsive to the receiving of the request to transfer a transfer value from a first transaction account in the transaction blockchain:
generating the primary-glyph by encoding the least some of the information about the request to transfer value from the first transaction account into a renderable data object; and
selecting one or more associated-glyphs; and
wherein transmitting the primary-glyph comprises transmitting the associated-glyphs.

13. The method of claim 12, wherein the transfer-completion message further includes an indication that a client-device scanned the primary-glyph and the one or more associated-glyphs.

14. The method of claim 12, wherein the primary-glyph is a GS1 databar barcode and wherein the associated-glyphs are Universal Product Code (UPC) barcode.

15. The method of claim 9, wherein at least some of the servers use one or more virtual-servers to perform at least some of the operations.

16. The method of claim 9, wherein updating, in a transaction blockchain, one or more transaction accounts by an update amount is performed responsive to and based on the updating of the longterm blockchain.

17. A tangible computer-readable device product instructions thereon that, when executed by computing devices, cause the computing devices to perform operations including:
receive a message containing a notification of a change to a longterm value that is recorded outside of a longterm blockchain comprising one or more longterm accounts;
responsive to receiving the message containing the notification, updating the one or more longterm accounts in the longterm blockchain to record the change to the longterm value that is recorded outside of the longterm blockchain;
after updating the longterm blockchain, updating, in a transaction blockchain, separate from the longterm blockchain, one or more transaction accounts by an update amount, the update amount generated based on the change to the one or more longterm accounts such that a total value of all transaction accounts in the transaction blockchain is based on an aggregate measure of all of the longterm accounts in the longterm blockchain.

18. The computer-readable product of claim 17, wherein the operations further comprise:
receiving a request to transfer a transfer value from a first transaction account in the transaction blockchain;
transmitting, based on receiving the request to transfer value from the first transaction account, a primary-glyph, the primary-glyph comprising elements that encode at least some of the information about the request to transfer value from the first transaction account;
receiving, after transmitting the primary-glyph, a transfer-completion message that includes at least some of the information about the request to transfer value from the first transaction account.

19. The computer-readable product of claim 18, wherein the operations further comprise transferring the transfer value from the first transaction account to a second transaction account in the transaction blockchain.

20. The computer-readable product of claim 18, wherein the operations further comprise:
responsive to the receiving of the request to transfer a transfer value from a first transaction account in the transaction blockchain:
generating the primary-glyph by encoding the least some of the information about the request to transfer value from the first transaction account into a renderable data object; and
selecting one or more associated-glyphs; and
wherein transmitting the primary-glyph comprises transmitting the associated-glyphs.
